(19) United States
(12) Patent Application Publication
(10) Pub. No.: US 2013/0152233 A1
(43) Pub. Date: Jun. 13, 2013

(54) 5-FLUOROCYTOSINE AS A SEED TREATMENT AGENT TO CONTROL PLANT DISEASE

(71) Applicants: Beth Lorsbach, Indianapolis, IN (US); Carla J.R. Klittich, Zionsville, IN (US); W. John Owen, Carmel, IN (US); Chenglin Yao, Westfield, IN (US)

(72) Inventors: Beth Lorsbach, Indianapolis, IN (US); Carla J.R. Klittich, Zionsville, IN (US); W. John Owen, Carmel, IN (US); Chenglin Yao, Westfield, IN (US)

(73) Assignee: Dow AgroSciences LLC, Indianapolis, IN (US)

(21) Appl. No.: 13/490,057

(22) Filed: Jun. 6, 2012

Related U.S. Application Data
(60) Provisional application No. 61/495,162, filed on Jun. 9, 2011.

(51) Int. Cl. A01N 43/54

(52) U.S. Cl. CPC A01N 43/54
USPC 800/298; 514/274

(57) ABSTRACT

The present disclosure relates to the use of 5-fluorocytosine as a seed treatment to prevent or control plant diseases.

### CROSS REFERENCE TO RELATED APPLICATIONS

This application claims the benefit of U.S. Provisional patent application Ser. No. 61/495,162, filed Jun 09, 2011, which is incorporated herein by reference in its entirety.

### FIELD OF THE INVENTION

The present invention relates to methods of controlling phytopathogenic fungi by treating seeds and/or seedling with a fungicide.

BACKGROUND

In agriculture, seed treatments or seed dressings have been used to treat seeds prior to planting. The term “seed treatment” includes all suitable seed treatment techniques known in the art, such as seed dressing, seed coating, seed dusting, seed imbibition (soaking), seed foaming (i.e. covering in foam) and seed pelleting, and refers preferably to the application of a fungicidally active compound(s) directly to the seeds themselves, prior to planting, and/or in their immediate vicinity during planting.

### SUMMARY OF THE INVENTION

Aspects of the invention include either plant seeds or plant seedling, comprising: either a seed; or a seedling and a disease-inhibiting and phytologically acceptable amount of 5-fluorocytosine, wherein said seed is contacted with the disease-inhibiting and phytologically acceptable amount of 5-fluorocytosine to form a treated seed that germinates to form a plant that is more resistant to fungal attack than is a plant from a similar untreated seed that has not been contacted with the a disease-inhibiting and phytologically acceptable amount of 5-fluorocytosine. In some embodiments the seed is treated with 5-fluorocytosine either before or after it is planted. In some embodiments the seedling is treated with 5-fluorocytosine either before or after it is transplanted.

In some embodiments of the invention the disease-inhibiting and phytologically acceptable amount of 5-fluorocytosine used to create the treated seed or seedling is in a liquid form or a solid form. In some embodiments the disease-inhibiting and phytologically acceptable amount of 5-fluorocytosine is between about 0.5 g to about 500 g of 5-fluorocytosine per 100 kg of seed or seedling. In some embodiments the disease-inhibiting and phytologically acceptable amount of 5-fluorocytosine is between about 1.8 g to about 16.5 g of 5-fluorocytosine per 100 kg of seed or seedling. In some embodiments the disease-inhibiting and phytologically acceptable amount of 5-fluorocytosine is between about 5.5 g to about 16.5 g of 5-fluorocytosine per 100 kg of seed or seedling. In some embodiments the disease-inhibiting and phytologically acceptable amount of 5-fluorocytosine is about 16.5 g of 5-fluorocytosine per 100 kg of seed or seedling. In some embodiments the plant seed or seedling treated with 5-fluorocytosine is treated with at least one additional fungicide.

Some aspects of the invention include methods for protecting a plant from fungal attack, comprising the steps of: contacting a seed or a seedling with a disease-inhibiting and phytologically acceptable amount of 5-fluorocytosine. In some embodiments the seed or seedling is further contacted with at least one additional fungicide.

An embodiment of the present disclosure may include a method for the control or prevention of fungal attack on a plant, the method including the steps of applying a fungicidally effective amount of 5-fluorocytosine to a seed adapted to produce the plant.

One aspect of the present disclosure is a method for controlling phytopathogenic fungi in and/or on a plant, wherein the seeds, from which the plant is expected to grow, before sowing and/or after pregermination, are treated with 5-fluorocytosine.

Additional features and advantages of the present disclosure will become apparent to those skilled in the art upon consideration of the following detailed description of the illustrative embodiments exemplifying the best mode of carrying out the invention as presently perceived.

### DETAILED DESCRIPTION OF THE DISCLOSURE

The embodiments of the disclosure described herein are not intended to be exhaustive or to limit the invention to the precise forms disclosed. Rather, the embodiments selected for description have been chosen to enable one skilled in the art to practice the invention.

Unless noted otherwise or clearly intended otherwise the term about as used herein refers to a range of values from plus to minus 10 percent. For example, the term about 1.0 refers to a range of values that includes 0.9 to 1.1.

Seed treatment can independently include application of 5-fluorocytosine directly to the seed as a coating or application to the seed environment as either a liquid or a solid formulation. Additionally, 5-fluorocytosine may be applied as a liquid or solid formulation to a seeding or to a seeding environment.

A seed is broadly interpreted to include anything that can be sown and can potentially be set in place (soil) to grow a crop. The term “seed” embraces seeds and plant propagules of all kinds including, but not limited to, true seeds, seed pieces, grains, suckers, corms, bulbs, fruit, tubers, cuttings, cut shoots and similar forms, and preferably means a true seed.

A seedling is a germinated seed.

A seedling environment is the soil or other growth medium surrounding the seedling.

The present invention contemplates all vehicles by which 5-fluorocytosine can be formulated for delivery and use as a seed treatment fungicide. Conventional seed treatment formulations include for example, flowable concentrates, suspensions, solutions, powders for dry treatment, water dispersible powders for slurry treatment, water-soluble powders and emulsion and gel formulations. These formulations can be applied diluted or undiluted.

Formulations may be applied following dilution of the concentrated formulation with water as aqueous solutions, suspensions or emulsions, or combinations thereof. Such solutions, suspensions or emulsions may be produced from water-soluble, water-suspendible, or emulsifiable formulations or combinations thereof; or solids including and usually known as wettable powders or water dispersible granules; or liquids including and usually known as emulsifiable concentrates, aqueous suspensions or suspension concentrates, and aqueous emulsions or emulsions in water, or mixtures thereof such as suspension-emulsions. As will be readily appreciated, any material to which this composition can be added may be used, provided it yields the desired utility without significant interference with the desired activity of the pesticidally active ingredients as pesticidal agents and improved residual lifetime or decreased effective concentration is achieved.

Wettable powders, which may be compacted to form water dispersible granules, comprise an intimate mixture of one or more of the pesticidally active ingredients, an inert carrier and surfactants. The concentration of the pesticidally active ingredient in the wettable powder is usually from about 10 percent to about 90 percent by weight based on the total weight of the wettable powder, more preferably about 25 weight percent to about 75 weight percent. In the preparation of wettable powder formulations, the pesticidally active ingredients can be compounded with any finely divided solid, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier and surfactants are typically blended with the compound(s) and milled.

Emulsifiable concentrates of the pesticidally active ingredient comprise a convenient concentration, such as from about 10 weight percent to about 50 weight percent of the pesticidally active ingredient, in a suitable liquid, based on the total weight of the concentrate. The pesticidally active ingredients are dissolved in an inert carrier, which is either a water miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum such as heavy aromatic naphtha. Other organic solvents may also be used, such as, for example, terpenic solvents, including rosin derivatives, aliphatic ketones, such as cyclohexanone, and complex alcohols, such as 2-ethoxyethanol.

Emulsifiers which can be advantageously employed herein can be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters esterified with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts of sulfated polyglycol ethers and appropriate salts of phosphated polyglycol ether.

Representative organic liquids which can be employed in preparing emulsifiable concentrates are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dim-ethyl amides; and glycol ethers such as the n-butyl ether, ethyl ether or methyl ether of diethylene glycol, and the methyl ether of triethylene glycol and the like. Mixtures of two or more organic liquids may also be employed in the preparation of the emulsifiable concentrate. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the emulsifying agents. The formulations can also contain other compatible additives, for example, plant growth regulators and other biologically active compounds used in agriculture.

Aqueous suspensions may comprise suspensions of one or more pesticidally active ingredients, which exhibit low solubility in water, dispersed in an aqueous vehicle at a concentration in the range from about 5 to about 50 weight percent, based on the total weight of the aqueous suspension. Suspensions are prepared by finely grinding one or more of the pesticidally active ingredients and vigorously mixing the ground material into a vehicle comprised of water and surfactants chosen from the same types discussed above. Other components, such as inorganic salts and synthetic or natural gums, may also be added to increase the density and viscosity of the aqueous vehicle. It is often most effective to grind and mix at the same time by preparing the aqueous mixture and homogenizing it in an implement such as a sand mill, ball mill, or piston-type homogenizer.

Aqueous emulsions comprise emulsions of one or more pesticidally active ingredients, which exhibit low solubility in water, emulsified in an aqueous vehicle at a concentration typically in the range from about 5 to about 50 weight percent, based on the total weight of the aqueous emulsion. If the pesticidally active ingredient is a solid it must be dissolved in a suitable water-immiscible solvent prior to the preparation of the aqueous emulsion. Emulsions are prepared by emulsifying the liquid pesticidally active ingredient or water-immiscible solution thereof into an aqueous medium typically with inclusion of surfactants that aid in the formation and stabilization of the emulsion as described above. This is often accomplished with the aid of vigorous mixing provided by high shear mixers or homogenizers.

The compositions of the present disclosure can also be granular formulations, which are particularly useful for applications to the soil. Granular formulations usually contain from about 0.5 to about 10 weight percent, based on the total weight of the granular formulation of the pesticidally active ingredient(s), dispersed in an inert carrier which consists entirely or in large part of coarsely divided inert material such as attapulgite, bentonite, diatomite, clay or a similar inexpensive substance. Such formulations are usually prepared by dissolving the pesticidally active ingredients in a suitable solvent and applying it to a granular carrier which has been preformed to the appropriate particle size, in the range of from about 0.5 to about 3 mm. A suitable solvent is a solvent in which the compound is substantially or completely soluble. Such formulations may also be prepared by making a dough or paste of the carrier and the compound and solvent, and crushing and drying to obtain the desired granular particle.

Dusts may be prepared by intimately mixing one or more of the pesticidally active ingredients in powdered form with a suitable dusty agricultural carrier, such as, for example, kaolin clay, ground volcanic rock, and the like. Dusts can suitably contain from about 1 to about 10 weight percent of the compounds, based on the total weight of the dust.

The formulations may additionally contain adjuvant surfactants and polymers to enhance adhesion and flowability and decrease dust-off of active ingredients. These adjuvants may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters of sulfosuccinic acids, ethoxylated organosilicones, ethoxylated fatty amines and blends of surfactants with mineral or vegetable oils. The formulations may also include oil-in-water emulsions such as those disclosed in U.S. patent application Ser. No. 11/495,228, the disclosure of which is expressly incorporated by reference herein.

The formulations may optionally include combinations that contain other pesticidal compounds. Such additional pesticidal compounds may be fungicides, insecticides, nematocides, miticides, arthropodicides, bactericides or combinations thereof that are compatible with the mixtures of the present invention in the medium selected for application and not antagonistic to the activity of the present mixtures. Accordingly, in such embodiments, the other pesticidal compound is employed as a supplemental toxicant for the same or for a different pesticidal use. The mixtures of the present invention, and the pesticidal compound in the combination can generally be present in a weight ratio of from 1:100 to 100:1.

The term “polymer” or “polymeric material” as used in this invention is taken to mean either a single polymer or a combination of different polymers or a copolymer. The particle comprises from about 50% to about 99% by weight of the polymeric material, preferably from about 50% to about 90% by weight.

Examples of suitable polymers for the practice of this invention include but are not limited to the following non-exhaustive list of polymers (and copolymers and mixtures thereof): poly(methylmethacrylate); poly(lactic acid) (Chronopols 50, 95, and 100) and copolymers such as poly(lactic acid-glycolic acid) copolymers (Lactel BP-400) and combinations with polystyrene, for example; cellulose acetate butyrate; poly(styrene); hydroxybutyric acid-hydroxyvaleric acid copolymers (Biopol D400G); styrene maleic anhydride copolymers (SMA 1440 A Resin, Sartomer Co.); poly(methylvinyl ether-maleic acid); poly(caprolactone); poly(n-amylmethacrylate); wood rosin; polyanhydrides, e.g., poly(sebacic anhydride), poly(valeric anhydride), poly(trimethylene carbonate), etc., and copolymers such as poly(carboxyphenoxypropane-sebacic acid), poly(fumaric acid-sebacic acid), etc.; polyorthoesters; poly(cyanoacrylates); poly(dioxanone); ethyl cellulose; ethyl vinyl acetate polymers and copolymers; poly(ethylene glycol); poly(vinylpyrrolidone); acetylated mono-, di-, and triglycerides; poly(phosphazene); chlorinated natural rubber; vinyl polymers and copolymers; polyvinyl chloride; hydroxyalkylcelluloses; polybutadiene; polyurethane; vinylidene chloride polymers and copolymers; styrene-butadiene copolymers; styrene-acrylic copolymers; vinyl acetate polymers and copolymers (e.g., vinyl acetate-ethylene copolymers (Vinumuls) and vinyl acetate-vinylpyrrolidone copolymers; alkylvinylether polymers and copolymers; cellulose acetate phthalates; ethyl vinyl pthalates; cellulose triacetate; polyanhydrides; polyglutamates; polyhydroxy butyrates; acrylic polymers (Rhoplexes); alkyl acrylate polymers and copolymers; aryl acrylate polymers and copolymers; aryl methacrylate polymers and copolymers; poly(caprolactams) (i.e., the nitrogen-containing counterparts to caprolactones); epoxy/polyamine epoxy/polyamides; polyvinyl alcohol polymers and copolymers; polyvinyl alcohol polymers and copolymers; silicones; polyesters (for oil-based approaches, including alkyds); phenolics (polymers and copolymers with drying oils).

In one embodiment, the polymer used in the compositions of the present invention is selected from the group consisting of poly(methylmethacrylate), poly(lactic acid), poly(lactic acid-glycolic acid) copolymers, cellulose acetate butyrate, poly(styrene), hydroxybutyric acid-hydroxyvaleric acid copolymers, styrene maleic anhydride copolymers, poly(methylvinyl ether-maleic acid), poly(caprolactone), poly(n-amylmethacrylate), wood rosin, polyanhydrides, polyorthoesters, poly(cyanoacrylates), poly(dioxanone), ethyl cellulose, ethyl vinyl acetate polymers, poly(ethylene glycol), poly(vinylpyrrolidone), acetylated mono-, di-, and trigylcerides, poly(phosphazene), chlorinated natural rubber, vinyl polymers, polyvinyl chloride, hydroxyalkylcelluloses, polybutadiene, polyurethane, vinylidene chloride polymers, styrene-butadiene copolymers, styrene-acrylic copolymers, alkylvinylether polymers, cellulose acetate phthalates, ethyl vinyl pthalates, cellulose triacetate, polyanhydrides, polyglutamates, polyhydroxy butyrates, polyvinyl acetate, vinyl acetate-ethylene copolymers, vinyl acetate-vinylpyrrolidone copolymers, acrylic polymers, alkyl acrylate polymers, aryl acrylate polymers, aryl methacrylate polymers, poly(caprolactams), epoxy resins, polyamine epoxy resins, polyamides, polyvinyl alcohol polymers, polyalkyd resins, phenolic resins, abietic acid resins, silicones, polyesters, and copolymers and combinations thereof.

Preferred polymers include poly(methylmethacrylate), poly(lactic acid) (Chronopols 50, 95, or 100), and combinations with polystyrene, poly(lactic acid-glycolic acid) copolymers (Lactel BP-400), cellulose acetate butyrate, and poly(styrene).

5-Fluorocytosine may also be combined with agricultural fungicides to form fungicidal mixtures and synergistic mixtures thereof and be applied to a seed or to a seedling. The fungicidal mixtures are often applied to control a wider variety of undesirable fungi that can result in plant pathology or contribute to the rise of fungicidal resistant fungi. When used in conjunction with other fungicide(s), 5-fluorocytosine can be formulated with the other fungicide(s), tank mixed with the other fungicide(s) or applied sequentially with the other fungicide(s) to a seed. Such other fungicides include, ametoctradin, azoxystrobin, Bacillus subtilis, benalaxyl, benomyl, benthiavalicarb-isopropyl, bitertanol, bixafen, boscalid, captan, carbendazim, carboxin, carpropamid, chlorothalonil, Coniothyrium minitans, copper hydroxide, copper octanoate, copper oxychloride, copper sulfate, copper sulfate (tribasic), cuprous oxide, cyazofamid, cyflufenamid, cyproconazole, cyprodinil, diethofencarb, difenoconazole, dimethomorph, dimoxystrobin, enestrobin, epoxiconazole, ethaboxam, famoxadone, fenamidone, fenarimol, fenbuconazole, fenpiclonil, fluazinam, fludioxonil, flumorph, fluopicolide, fluopyram, fluoxastrobin, fluquinconazole, flusilazole, flutianil, flutolanil, flutriafol, fluxapyroxad, fosetyl, fosetyl-aluminium, guazatine, hexaconazole, hymexazol, imazalil, imazalil sulfate, imibenconazole, iminoctadine, iminoctadine triacetate, ipconazole, ipfenpyrazolone, iprobenfos, iprodione, iprovalicarb, isopyrazam, isotianil, mancozeb, mandipropamid, maneb, metalaxyl, mefenoxam, metalaxyl-M, metconazole, methasulfocarb, methyl iodide, methyl isothiocyanate, metiram, metominostrobin, metrafenone, myclobutanil, ofurace, orysastrobin, oxadixyl, oxine-copper, penconazole, penflufen, penthiopyrad, picoxystrobin, probenazole, prochloraz, procymidone, propamocarb, propamocarb hydrochloride, propiconazole, proquinazid, prothioconazole, pyraclostrobin, pyrametostrobin, pyraoxystrobin, pyrazophos, pyribencarb, pyrimethanil, sedaxane, silthiofam, simeconazole, spiroxamine, tebuconazole, tebufloquin, tetraconazole, thiabendazole, thiophanate-methyl, thiram, tiadinil, tolclofos-methyl, triadimenol, triazoxide, tricyclazole, trifloxystrobin, triticonazole, zoxamide, Trichoderma spp., 5-fluorocytosine and profungicides thereof, picolinamide UK-2A and derivatives thereof,

Additionally, 5-fluorocytosine may be combined with other pesticides, including insecticides, nematocides, miticides, arthropodicides, bactericides or combinations thereof that are compatible with the 5-fluorocytosine in the medium selected for application, and not antagonistic to the activity of 5-fluorocytosine to form pesticidal mixtures and synergistic mixtures thereof 5-Fluorocytosine can be applied in conjunction with one or more other pesticides to control a wider variety of undesirable pests. When used in conjunction with other pesticides, 5-fluorocytosine can be formulated with the other pesticide(s), tank mixed with the other pesticide(s) or applied sequentially with the other pesticide(s) to a seed. Typical insecticides include, but are not limited to: antibiotic insecticides such as allosamidin and thuringiensin; macrocyclic lactone insecticides such as spinosad and spinetoram; ivermectin insecticides such as abamectin, doramectin, emamectin, eprinomectin, ivermectin and selamectin; milbemycin insecticides such as lepimectin, milbemectin, milbemycin oxime and moxidectin; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dessicant insecticides such as boric acid, diatomaceous earth and silica gel; diamide insecticides such as chlorantraniliprole, cyantraniliprole and flubendiamide; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as α-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethyl-amine insecticides such as acetamiprid, imidacloprid, nitenpyram and thiacloprid; organochlorine insecticides such as bromo-DDT, camphechlor, DDT, pp'-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, alpha-endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, isofenphos-methyl, methamidophos and propetamphos; phosphorodiamide insecticides such as dimefox, mazidox, mipafox and schradan; oxadiazine insecticides such as indoxacarb; oxadiazoline insecticides such as metoxadiazone; phthalimide insecticides such as dialifos, phosmet and tetramethrin; pyrazole insecticides such as tebufenpyrad, tolefenpyrad; phenylpyrazole insecticides such as acetoprole, ethiprole, fipronil, pyrafluprole, pyriprole and vaniliprole; pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, meperfluthrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tetramethylfluthrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetramic acid insecticides such as spirotetramat; tetronic acid insecticides such as spiromesifen; thiourea insecticides such as diafenthiuron; urea insecticides such as flucofuron and sulcofuron; and unclassified insecticides such as closantel, copper naphthenate, crotamiton, EXD, fenazaflor, fenoxacrim, hydramethylnon, isoprothiolane, malonoben, metaflumizone, nifluridide, plifenate, pyridaben, pyridalyl, pyrifluquinazon, rafoxanide, sulfoxaflor, triarathene and triazamate, and any combinations thereof.

5-Fluorocytosine and/or mixtures thereof are effective in use with plants in a disease-inhibiting and phytologically acceptable amount. The term “disease inhibiting and phytologically acceptable amount” refers to an amount of a mixture that kills or inhibits the plant disease for which control is desired, but is not significantly toxic to the plant. The exact amount of a mixture required varies with the fungal disease to be controlled, the type of formulation employed, the method of application, the particular plant species, climate conditions, and the like. The dilution and rate of application will depend upon the type of equipment employed, the method and frequency of application desired and diseases to be controlled.

As a seed protectant, the amount of 5-fluorocytosine applied to the seed or seedling is usually at a dosage rate of about 0.5 to about 500 grams (g) per 100 kilograms of seed.

Additionally, 5-fluorocytosine may be combined with herbicides that are compatible with 5-fluorocytosine in the medium selected for application, that are not antagonistic to the activity of 5-fluorocytosine, and that are not themselves phytotoxic to the seeds, seedlings, or plants of interest, in order to form agriculturally active mixtures and/or synergistic mixtures thereof. The 5-fluorocytosine may be applied in conjunction with one or more herbicies to control a wide variety of undesirable plants. When used in conjunction with herbicides, 5-fluorocytosine may be formulated with the herbicide(s), tank mixed with the herbicide(s) or applied sequentially with the herbicide(s). Typical herbicides may include, but are not limited to: amide herbicides such as allidochlor, beflubutamid, benzadox, benzipram, bromobutide, cafenstrole, CDEA, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides such as benzofluor, perfluidone, pyrimisulfan and profluazol; sulfonamide herbicides such as asulam, carbasulam, fenasulam and oryzalin; thioamide herbicides such as chlorthiamid; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; benzothiazole herbicides such as benzazolin; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glufosinate-P, glyphosate and piperophos; phenoxy herbicides such as bromofenoxim, clomeprop, 2,4-DEB, 2,4-DEP, difenopenten, disul, erbon, etnipromid, fenteracol and trifopsime; oxadiazoline herbicides such as methazole, oxadiargyl, oxadiazon; oxazole herbicides such as fenoxasulfone; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazole herbicides such as pyroxasulfone; benzoylpyrazole herbicides such as benzofenap, pyrasulfotole, pyrazolynate, pyrazoxyfen, and topramezone; phenylpyrazole herbicides such as fluazolate, nipyraclofen, pioxaden and pyraflufen; pyridazine herbicides such as credazine, pyridafol and pyridate; pyridazinone herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluroxypyr, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, indaziflam, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, ipfencarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as benzfendizone, bromacil, butafenacil, flupropacil, isocil, lenacil, saflufenacil and terbacil; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, nicosulfuron, orthosulfamuron, oxasulfuron, primisulfuron, propyrisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluron and thidiazuron; and unclassified herbicides such as acrolein, allyl alcohol, aminocyclopyrachlor, azafenidin, bentazone, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan and tritac.

Another embodiment of the present disclosure is a method for the control or prevention of fungal attack. This method comprises applying to the seed a fungicidally effective amount of 5-fluorocytosine. 5-Fluorocytosine is suitable for treatment of various plants at fungicidal levels, while exhibiting low phytotoxicity. The compound may be useful both in a protectant and/or an eradicant fashion.

5-Fluorocytosine has been found to have significant fungicidal effect particularly for agricultural use. 5-Fluorocytosine is particularly effective for use with agricultural crops and horticultural plants. Additional benefits may include, but are not limited to, improving the health of a plant; improving the yield of a plant (e.g. increased biomass and/or increased content of valuable ingredients); improving the vigor of a plant (e.g. improved plant growth and/or greener leaves); improving the quality of a plant (e.g. improved content or composition of certain ingredients); and improving the tolerance to abiotic and/or biotic stress of the plant.

It will be understood by those in the art that the efficacy of 5-fluorocytosine for the following fungi establishes the general utility of the compound as a fungicide.

5-Fluorocytosine has broad ranges of activity against fungal pathogens. Exemplary pathogens may include, but are not limited to, wheat leaf blotch (Septoria tritici, also known as Mycosphaerella graminicola), apple scab (Venturia inaequalis), and Cercospora leaf spots of sugar beets (Cercospora beticola), leaf spots of peanut (Cercospora arachidicola and Cercosporidium personatum) and other crops, and black sigatoka of bananas (Mycosphaerella fujiensis). The exact amount of the active material to be applied is dependent not only on the specific formulation being applied, but also on the particular action desired, the fungal species to be controlled, and the stage of growth thereof, as well as the part of the plant or other product to be contacted with the compound.

5-Fluorocytosine is effective in use with plants in a disease-inhibiting and phytologically acceptable amount. The term “disease-inhibiting and phytologically acceptable amount” refers to an amount of a compound that kills or inhibits the plant disease for which control is desired, but is not significantly toxic to the plant. This amount will generally be from about 0.5 to about 500 g ai/100 kg seed. The exact amount of 5-fluorocytosine required varies with the fungal disease to be controlled, the type of formulation employed, the method of application, the timing of the application, the particular plant species, climate conditions, and the like.

Any range or desired value given herein may be extended or altered without losing the effects sought, as is apparent to the skilled person for an understanding of the teachings herein.

Evaluation of Fungicidal Activity as a Seed Treatment for Leaf Blotch of Wheat (Mycosphaerella graminicola; anamorph: Septoria tritici; Bayer code SEPTTR)

Seeds of wheat variety ‘Yuma’ were treated with a 1% weight-to-volume (w/v) solution of 5-fluorocytosine in water at rates of 16.5, 5.5, 1.8, and 0 grams of active ingredient per 100 kilograms (g ai/100 kg) of seeds. A red dye and a polymer blend were included in the formulation as inert ingredients. Seeds were allowed to dry thoroughly and were sown 3 days (trial 1) or 5 weeks (trials 2 and 3) after treatment. Seeds (10-12 seeds/pot) were planted in 4 square inch pots containing 50% mineral soil/50% soil-less Metro mix. Eleven-day-old seedlings were inoculated with an aqueous spore suspension of Septoria tritici, and 6-10 pots of plants were inoculated for each fungicide rate. After inoculation, plants were kept in 100% relative humidity three days to allow establishment of infection. The plants were then transferred to a greenhouse until disease developed. When disease on untreated plants was fully expressed , disease severities on treated plants were assessed. At the test rate of 16.5 g ai/100 kg seeds, 5-fluorocytosine (Table 1) provided a significant level of control of SEPTTR. Trial 1 was the average of 10 pots of plants; Trial 2 was the average of 6 pots of plants; and Trial 3 was the average of 6 pots of plants placed in weigh boats in order to prevent possible loss of the 5-fluorocytosine from soil leaching.

The following tables include data showing the activity of 5-fluorocytosine when evaluated in these experiments. The effectiveness of 5-fluorocytosine in controlling disease was determined by assessing the severity of disease on treated plants, then converting the severity to percent control based on the level of disease on untreated, inoculated plants.

TABLE 1
the rating scale is as follows:

| % Disease Control | Rating |
|---|---|
| 76-100 | A |
| 51-75 | B |
| 26-50 | C |
| 1-25 | D |
| 0 | 0 |

TABLE 2
Summary of SEPTTR control delivered by
5-fluorocytosine treated Yuma seeds

| | % Disease control | | |
|---|---|---|---|
| Rate (g ai/100 kg seeds) | Trial 1 | Trial 2 | Trial 3 |
| 16.5 | A | A | A |
| 5.5 | C | A | A |
| 1.8 | D | C | C |
| 0 | 0 | 0 | 0 |

What is claimed is:

1. A plant seed, comprising:
a seed; and
a disease-inhibiting and phytologically acceptable amount of 5-fluorocytosine, wherein said seed is contacted with the disease-inhibiting and phytologically acceptable amount of 5-fluorocytosine to form a treated seed that germinates to form a plant wherein the plant that forms is more resistant to fungal attack than is a plant from a similar untreated seed that has not been contacted with the a disease-inhibiting and phytologically acceptable amount of 5-fluorocytosine.

2. The plant seed of claim 1, wherein said seed is contacted with the disease-inhibiting and phytologically acceptable amount of 5-fluorocytosine before the treated seed is planted.

3. The plant seed of claim 1, wherein said seed is contacted with the disease-inhibiting and phytologically acceptable amount of 5-fluorocytosine after the seed is planted.

4. The plant seed of claim 1, wherein the disease-inhibiting and phytologically acceptable amount of 5-fluorocytosine used to create the treated seed is in a liquid form or a solid form.

5. The plant seed of claim 1, wherein the disease-inhibiting and phytologically acceptable amount of 5-fluorocytosine is between about 0.5 g to about 500 g of 5-fluorocytosine per 100 kg of seed.

6. The plant seed of claim 1, wherein the disease-inhibiting and phytologically acceptable amount of 5-fluorocytosine is between about 1.8 g to about 16.5 g of 5-fluorocytosine per 100 kg of seed.

7. The plant seed of claim 1, wherein the disease-inhibiting and phytologically acceptable amount of 5-fluorocytosine is between about 5.5 g to about 16.5 g of 5-fluorocytosine per 100 kg of seed.

8. The plant seed of claim 1, wherein the disease-inhibiting and phytologically acceptable amount of 5-fluorocytosine is about 16.5 g of 5-fluorocytosine per 100 kg of seed.

9. The plant seed of claim 1, further including at least one additional fungicide.

10. A plant seedling, comprising
a plant seedling; and
a disease-inhibiting and phytologically acceptable amount of 5-fluorocytosine, wherein the plant seedling is treated with said disease-inhibiting and phytologically acceptable amount of 5-fluorocytosine to form a treated plant seedling, and wherein the treated plant seedling is more resistant to fungal attack than is a seedling that is not treated with said disease-inhibiting and phytologically acceptable amount of 5-fluorocytosine.

11. The plant seedling of claim 10, wherein said seedling is contacted with the disease-inhibiting and phytologically acceptable amount of 5-fluorocytosine before the treated seedling is transplanted.

12. The plant seedling of claim 10, wherein said seed is contacted with the disease-inhibiting and phytologically acceptable amount of 5-fluorocytosine after the seedling is transplanted.

13. The plant seedling of claim 10, wherein the disease-inhibiting and phytologically acceptable amount of 5-fluorocytosine used to create the treated seedling is in either a liquid form or a solid form.

14. The plant seedling of claim 10, wherein the disease-inhibiting and phytologically acceptable amount of 5-fluorocytosine is between about 0.5 g to about 500 g of 5-fluorocytosine per 100 kg of seedling.

15. The plant seedling of claim 10, wherein the disease-inhibiting and phytologically acceptable amount of 5-fluorocytosine is between about 1.8 g to about 16.5 g of 5-fluorocytosine per 100 kg of seedling.

16. The plant seedling of claim 10, wherein the disease-inhibiting and phytologically acceptable amount of 5-fluorocytosine is between about 5.5 g to about 16.5 g of 5-fluorocytosine per 100 kg of seedling.

17. The plant seedling of claim 10, wherein the disease-inhibiting and phytologically acceptable amount of 5-fluorocytosine is about 16.5 g of 5-fluorocytosine per 100 kg of seedling.

18. The plant seedling of claim 10, further including at least one additional fungicide.

19. A method of protecting a plant from fungal attack, comprising the steps of:
contacting a seed or a seedling with a disease-inhibiting and phytologically acceptable amount of 5-fluorocytosine.

20. The method according to claim 19, further including at least on additional fungicide.
